(19) United States
(12) Patent Application Publication
(10) Pub. No.: US 2001/0026453 A1
(43) Pub. Date: Oct. 4, 2001

(54) Multidirectional docking light

(76) Inventors: Ronald E. Wiggerman, McHenry, IL (US); Rudy Guzik, Frankfort, IL (US); Allan Boleslawski, Bear, DE (US)

Correspondence Address: GARDNER, CARTON & DOUGLAS, 321 N. CLARK STREET, SUITE 3400, CHICAGO, IL, 60610, US

(21) Appl. No.: 09/777,805

(22) Filed: Feb. 6, 2001

Related U.S. Application Data
(60) Provisional application No. 60/180,545, filed on Feb. 7, 2000.

(51) Int. Cl. B60Q 1/00; F21V 29/00

(52) U.S. Cl. 362/477; 362/287; 362/267; 362/418

(57) ABSTRACT

Disclosed is a multidirectional docking light where the direction of the light beam may be adjusted even after installation, and where the light may be simultaneously aimed in more than one direction. The docking light of the invention will assist boaters in viewing more areas surrounding the boat during docking that with conventional boat docking lights

### RELATED APPLICATION

This application claims the benefit of U.S. Provisional Application Ser. No. 60/180,545, filed on Feb. 2, 2000.

### FIELD OF THE INVENTION

This invention relates to marine lights and, move specifically to aiming and side illumination of mounted marine lights.

### BACKGROUND OF THE INVENTION

Many boats have lights mounted in the hull to illuminate in front of the boat and to illuminate a dock or pier as a boat is approaching. Often, these lights are similar to searchlights or floodlights, and the beam of light is often narrow and very bright. Accordingly, the brightness of such docking lights will cause areas that are not illuminated to appear very dark by contrast. This effect often obscures obstructions that may be near the boat but not in the path of the docking light, such as logs, small craft or even people.

These lights can be configured in canisters that are installed into the side of the boat's hull. Conventional canister units are hard-mounted into the hull, and if mounted incorrectly, are very difficult to change. These lights most often use sealed beam lights, which are designed to point in only one direction, in a straight line in front of the light. Thus, if illumination of more than one area is desired, more than one light must be installed, creating additional expense and maintenance for the boater. In addition, conventional lights are generally configured so that once they are installed it is very difficult, if not impossible, to adjust the direction of the light—if mounted incorrectly, the light shines in a direction other than as intended. In addition, currently available lights do not allow the reflector to be aimed after installation.

Because of the types of lights used as docking lights, such as sealed beam lights, and the way in which they are installed onto the boat, it is expensive to remount and replace prior art conventional boat docking lights.

There is a need, therefore, for a boat docking light in which the direction of the beam may be adjusted. There is a further need for a boat docking light assembly in which the light may be easily replaced as compared to prior art sealed beam docking lights. Lastly, there is a need for a boat docking light that is multidirectional, and can illuminate in directions other than a narrow beam extending outward from the bulb face, thus minimizing the number of lights that must be installed and maintained.

### SUMMARY OF THE INVENTION

It is an object of the invention to provide a boat docking light in which the direction of the beam may be adjusted.

It is also an object of the invention to provide a boat docking light assembly in which the light may be easily replaced.

It is yet another object of the invention to provide a multi-directional boat docking light.

The invention provides a novel multidirectional boat docking light whereby the direction of the light beam may be adjusted even after installation, and where the light may be aimed in more than one direction. The docking light of the invention will assist boaters in viewing more areas surrounding the boat during docking that with conventional boat docking lights.

### BRIEF DESCRIPTION OF THE DRAWINGS

Other objects and advantages of the invention will be apparent from the following detailed description and the accompanying drawings, in which:

FIG. 1 is a schematic diagram of one embodiment of the boat docking light of the invention;

FIG. 2 is an exploded view of the boat docking light of the invention; and

FIG. 3 is an exploded view of the light assembly of the invention.

### DETAILED DESCRIPTION OF THE PREFERRED EMBODIMENTS

The description herein of the preferred embodiments are for illustration purposes only. As those skilled in the art will understand, there are many variations and modifications of the device that will retain the spirit of the invention, and it is intended that such modifications and variations are within the scope of the multidirectional docking light described herein and in the appended claims. For instance, the invention illustrated herein is also suitable outside of the marine field where similar drawbacks are sought to be overcome, but the marine field is particularly suitable to the invention.

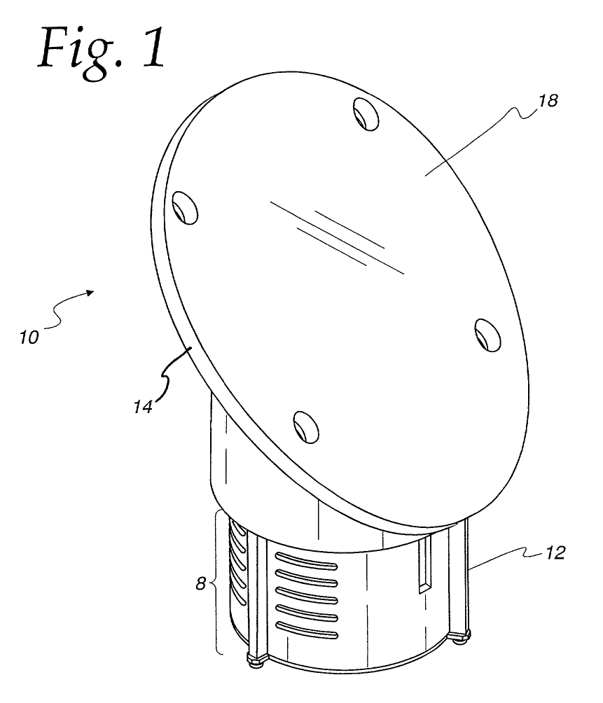

As illustrated in FIG. 1, the multidirectional docking light 10 of the present invention includes a generally tubular housing 8 that comprises a first end 12 generally shaped in the form of a canister, attached to a second outer mounting end 14. The mounting end 14 of housing 8 may be at least partly angled to correspond approximately to the shape of the side of the boat on which the docking light 10 is mounted, and is generally ovoid in shape and may optionally be of a larger outer diameter than the outer diameter of the canister end 12. The first canister end 12 and mounting end 14 may be constructed of metal, plastic or any other material suitably durable and heat resistant for use in a boat docking light, and those skilled in the art will be aware of a number of commercially available materials for such purpose. The light 10 is installed into a receptacle formed in the hull of a boat in accordance with methods well known in the art.

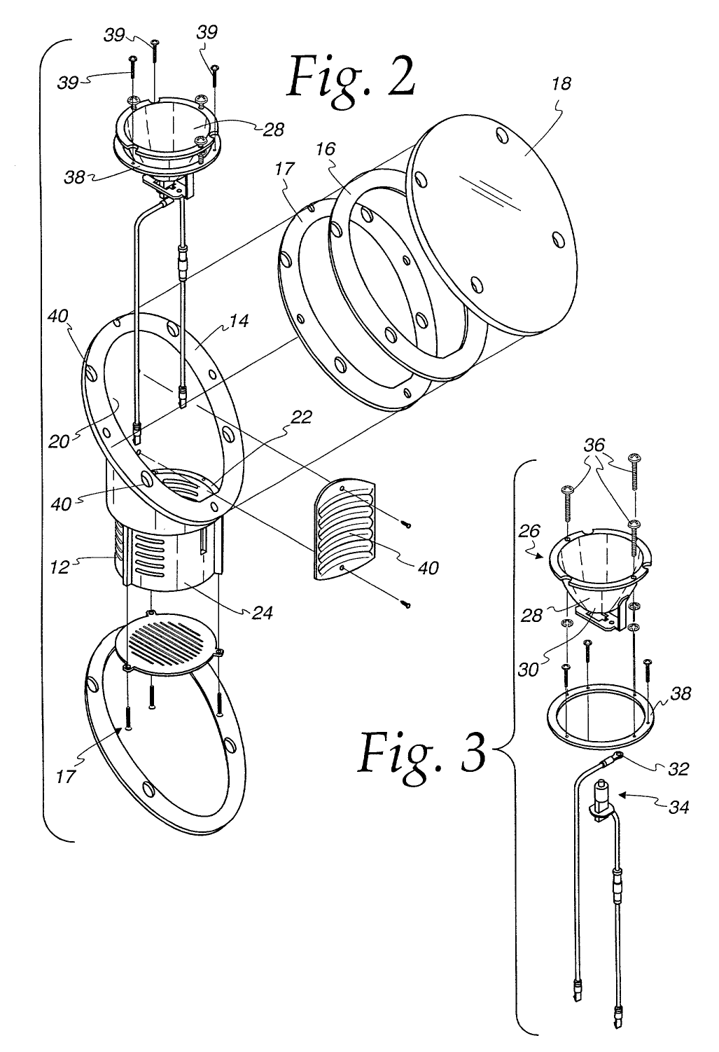

As shown in FIG. 2, a gasket 16 and one or more mounting rings 17 can be used to assist in fastening the mounting end 14 to the boat. The gasket 16 and mounting rings 17 may be made of any material suitable for this purpose such as but not limited to rubber, plastics, foams, or a combination of these, and a wide variety of commercially available gaskets are known to those skilled in the art. The mounting end 14, gasket 16 and mounting rings 17 are pre-configured with a plurality of aligned fastener openings 40 to aid in mounting the docking light to the boat. A lens 18 designed to fit over the opening in the outer mounting end 14 of the housing 8 is removably fastened to the outer mounting end 14. The lens 18 protects the internal components of the light 10 and allows for access into the housing 8 so that components can be replaced and repaired, and the reflectors adjusted. The lens 18 is also preconfigured with fastener openings to assist in mounting the lens 18 to the outer mounting end 14. The lens 18 is transparent and permits light from the bulb to shine through. The lens may be made of any material that is waterproof and sufficiently transparent for the purpose, and includes but is not limited to plastic, acrylic polymers and glasses. A number of suitable lens materials are commercially available and are generally known to those skilled in the art.

As depicted in FIG. 2, along the inner surface 20 of the mounting end 14 of housing 8, a rim 22 is positioned that extends into the center of the housing 8. The rim 22 is positioned between the outer mounting end 14 and the opposing distal end 24 of the canister end 12 of housing 8. A light assembly 26 can be removably attached to the rim 22 so that the light assembly 26 is contained within the housing 8 and protected by the lens 18.

The light assembly 26, as illustrated in FIG. 3, includes a reflecting bulb receptacle 28, which may be conically or cup-shaped for optimal illumination. At the vortex 30 of the bulb receptacle 28, a bulb 34 is placed. A variety of suitable bulbs are commercially available, and are generally known to boat operators. Such bulbs include but are not limited to incandescent bulbs, fluorescent bulbs and halogen bulbs. Through the vortex 30, the necessary electrical components 32 to illuminate the bulb 34, which are known in the art, are configured. The reflecting bulb receptacle 28 is connected to the mounting ring 38 by a plurality of commercially available adjustment screws 36, as shown in FIG. 3.

The configuration of the receptacle 28, the mounting rim 38 and the housing's rim 22 allow the position of the light to be adjusted approximately ±10° in the X and Y axis. As the adjustment screws 36 are turned the receptacle 28 is adjusted in the appropriate X or Y axis in a known manner. In this way, a direction of the light beam can be adjusted to the desired direction once the assembly of the present invention is installed over the hull.

In a further embodiment of the present invention also illustrated in FIG. 2, a reflector 40 is attached to the inner surface 20 of the mounting end 12. The reflector 40 is attached between the outer mounting end 12 of the housing 8, which is angled because of the shape of the hull, and the rim 22. Due to the shape of the outer mounting end 12 and the position of the reflector 40, the light emitted by the bulb 34 can be reflected in a forward direction as well as to the side of the boat, i.e. in a direction angular to the forward beam of light. The reflector 40 may be affixed in any position along the inner surface 20 of the outer mounting end 12, thus providing additional flexibility in choosing the angle of reflection of the non-forward light. The reflector may be attached by any suitable means, including but not limited to by hardware such as screws, or by adhesives, such as but not limited to epoxy. Thus, the docking light 10 of the present invention can be multi-directional in that the light shines to the front of the bulb and is reflected at an angle from the forward beam, thus increasing the visibility of the areas around the boat. This can be helpful as a boat approaches a dock.

What is claimed is:

1. A light mounted into the hull of the boat comprising:
a housing having a first canister end and a second mounting end and an internal rim there between;
a lighting assembly having a reflecting bulb receptacle and a light bulb;
a gasket affixed to the mounting end;
one or more mounting rings affixed to the gasket and the mounting end;
at least one adjustable screw to mount the lighting assembly within the housing and wherein the adjustable screw permits the movement of the lighting assembly within the housing to direct the position of the light; and
a lens covering the opening formed by the mounting end.

2. The light of claim 1, wherein the light bulb may be replaced without removing the lighting assembly.

3. The light of claim 1 wherein the light further contains a reflector mounted within the mounting end.

4. The light of claim 1 wherein light is emitted in more than one direction.

5. A light mounted into the hull of the boat comprising:
a housing having a generally canister-type shape first end and having an angled second mounting end mounted into the hull of the boat, and an internal rim between the first end and the second end;
a lighting assembly having a reflecting bulb receptacle and a light bulb wherein the lighting assembly is mounted to the rim of the housing and extends into the first end; and
a reflector attached to an inner surface of the mounting end of the housing so that the light emitted from the bulb is reflected in more than one direction simultaneously.

6. The light of claim 5, wherein the light further contains a lens and at least one gasket and at least one mounting ring, wherein the gasket and mounting rings are affixed between the lens and the mounting end, and wherein the lens is removably secured to the mounting end.

7. The light of claim 6 wherein the light further contains at least one adjustment screw affixing the lighting assembly within the rim, wherein the adjustment screw may be used to adjust the direction of the light beam emitted from the bulb.

8. The light of claim 7 wherein the light further comprises a removable lens affixed to the mounting end, wherein the lens is removed to change the bulb or adjust the angle of the light emitted from the bulb.
